(19) United States
(12) Patent Application Publication
(10) Pub. No.: US 2025/0171109 A1
(43) Pub. Date: May 29, 2025

(54) Electronic Steering Assist Systems for Snowmobiles

(71) Applicant: Arctic Cat Inc., Thief River Falls, MN (US)

(72) Inventors: Donald Dean Carr, Thief River Falls, MN (US); Mark William Christiansen, Thief River Falls, MN (US)

(73) Assignee: Arctic Cat Inc., Thief River Falls, MN (US)

(21) Appl. No.: 18/759,836

(22) Filed: Jun. 29, 2024

Related U.S. Application Data
(60) Provisional application No. 63/604,023, filed on Nov. 29, 2023.

(51) Int. Cl. B62M 27/02; B62D 5/04

(52) U.S. Cl. CPC B62M 27/02; B62D 5/0457; B62M 2027/027

(57) ABSTRACT

A snowmobile has a ski system and a drive track system including an endless track configured to provide ground propulsion for the snowmobile. An internal combustion engine is configured to provide torque and rotational energy to the drive track system. A stator system is operably associated with the engine. The stator system is configured to output first and second direct currents. At least one electrical load component is positioned in a first circuit associated with the first direct current. A steering system is operatively coupled to the ski system. The steering system includes an electronic steering assist unit that is positioned in a second circuit associated with the second direct current.

### CROSS-REFERENCE TO RELATED APPLICATIONS

The present application claims the benefit of U.S. Provisional Application No. 63/604,023, filed Nov. 29, 2023 the entire contents of which are hereby incorporated by reference.

### TECHNICAL FIELD OF THE DISCLOSURE

The present disclosure relates, in general, to electronic steering assist systems for use on land vehicles and, in particular, to electronic steering assist systems for use on snowmobiles that include an electronic steering assist unit that is electrically isolated from other electrical load components of the snowmobile.

### BACKGROUND

Snowmobiles are popular land vehicles used for transportation and recreation in cold and snowy conditions. Certain snowmobiles are designed for specific applications such as trail, utility, mountain, race and crossover, to name a few. Snowmobiles typically include a chassis that supports various components of the snowmobile such as an engine, a continuously variable transmission and a ground-engaging endless drive track disposed in a longitudinally extending tunnel. The engine and transmission power the drive track to enable ground propulsion for the vehicle. A rider controls the operation of the snowmobile using a steering system that typically includes a handlebar assembly, a steering column, a steering arm assembly, a pair of tie rods and a pair ski assemblies that provide flotation for the front of the snowmobile over the snow. Some snowmobiles utilize an electronic steering assist unit which can improve the handling of the snowmobile, reduce fatigue associated with driving the snowmobile and allow the snowmobile to be driven more aggressively. It has been found, however, that the intermittent power demand of the electronic steering assist unit can create voltage fluctuations that may adversely affect other electrical load components of the snowmobile that draw current generated by a stator that is integrated with the engine. Accordingly, a need has arisen for improved electronic steering assist systems for snowmobiles that overcome these and other drawbacks.

### SUMMARY

In a first aspect, the present disclosure is directed to a snowmobile having a ski system and a drive track system including an endless track configured to provide ground propulsion for the snowmobile. An internal combustion engine is configured to provide torque and rotational energy to the drive track system. A stator system is operably associated with the engine. The stator system is configured to output first and second direct currents. At least one electrical load component is positioned in a first circuit associated with the first direct current. A steering system is operatively coupled to the ski system. The steering system includes an electronic steering assist unit that is positioned in a second circuit associated with the second direct current.

In certain embodiments, the engine may be a two-stroke engine. In some embodiments, the at least one electrical load component may be an engine control module. In other embodiments, the at least one electrical load component may be one or more of lights, gauges, computer processors, heaters, a winch and a stereo. In certain embodiments, the stator system may include a stator and a regulator rectifier such that the stator outputs an alternating current to the regulator rectifier and the regulator rectifier outputs the first direct current to the first circuit and the second direct current to the second circuit. In such embodiments, a battery may be positioned in parallel with the electronic steering assist unit in the second circuit with the battery configured to be charged by the second direct current and with the battery configured as a store of energy for the electronic steering assist unit such that an intermittent high power demand of the electronic steering assist unit is satisfied by drawing current from the battery.

In some embodiments, the stator system may include a stator, a first regulator rectifier and a second regulator rectifier such that the stator outputs a first alternating current to the first regulator rectifier and a second alternating current to the second regulator rectifier and such that the first regulator rectifier outputs the first direct current to the first circuit and the second regulator rectifier outputs the second direct current to the second circuit. In such embodiments, a battery may be positioned in parallel with the electronic steering assist unit in the second circuit with the battery configured to be charged by the second direct current and with the battery configured as a store of energy for the electronic steering assist unit such that an intermittent high power demand of the electronic steering assist unit is satisfied by drawing current from the battery. In certain embodiments, the first and second direct currents may be at the same voltage. In other embodiments, the first and second direct currents may be at different voltages. In some embodiments, a battery may be configured to be charged by the second direct current. In such embodiments, the battery may be positioned in parallel with the electronic steering assist unit in the second circuit and configured as a store of energy for the electronic steering assist unit such that an intermittent high power demand of the electronic steering assist unit is satisfied by drawing current from the battery.

In a second aspect, the present disclosure is directed to a snowmobile having a ski system and a drive track system including an endless track configured to provide ground propulsion for the snowmobile. An electric motor is configured to provide torque and rotational energy to the drive track system. A steering system is operatively coupled to the ski system. The steering system includes an electronic steering assist unit. A power supply is configured to supply electric power to the electric motor and the electronic steering assist unit.

In some embodiments, the power supply may include a battery having an output voltage with both the electric motor and the electronic steering assist unit operating at the output voltage. In certain embodiments, the output voltage of the battery may be at least 48 volts such as between 48 volts and 300 volts. In some embodiments, the electric motor may operate at a first voltage and the electronic steering assist unit may operate at a second voltage that is less than the first voltage. In such embodiments, the power supply may include a first battery having an output voltage of the first voltage and a second battery having an output voltage of the second voltage. Also, in such embodiments, the first voltage may be between 48 volts and 300 volts, and the second voltage may be about 12 volts. In certain embodiments, the electric motor may operate at a first voltage and the electronic steering assist unit may operate at a second voltage that is less than the first voltage. In such embodiments, the power supply may include a battery having an output voltage of the first voltage and a DC to DC converter electrically coupled between the battery and the electronic steering assist unit that converters the first voltage to the second voltage. In such embodiments, the first voltage may be between 48 volts and 300 volts, and the second voltage may be about 12 volts.

In a third aspect, the present disclosure is directed to a method of electrically isolating an electronic steering assist unit from at least one electrical load component of a snowmobile. The method includes outputting first and second direct currents from a stator system operably associated with an internal combustion engine; positioning the at least one electrical load component in a first circuit associated with the first direct current; and positioning the electronic steering assist unit in a second circuit associated with the second direct current.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1E are selected views of a snowmobile having a steering system including an electronic steering assist unit in accordance with embodiments of the present disclosure;

FIG. 2 is an isometric view of a forward portion of a snowmobile having a steering system including an electronic steering assist unit in accordance with embodiments of the present disclosure;

FIGS. 3A-3E are selected views of a steering system for a snowmobile including an electronic steering assist unit in accordance with embodiments of the present disclosure;

FIGS. 4A-4C are block diagrams of various electrical system configurations for a snowmobile having a steering system including an electronic steering assist unit in accordance with embodiments of the present disclosure; and

FIGS. 5A-5C are block diagrams of various electrical system configurations for a snowmobile having a steering system including an electronic steering assist unit in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

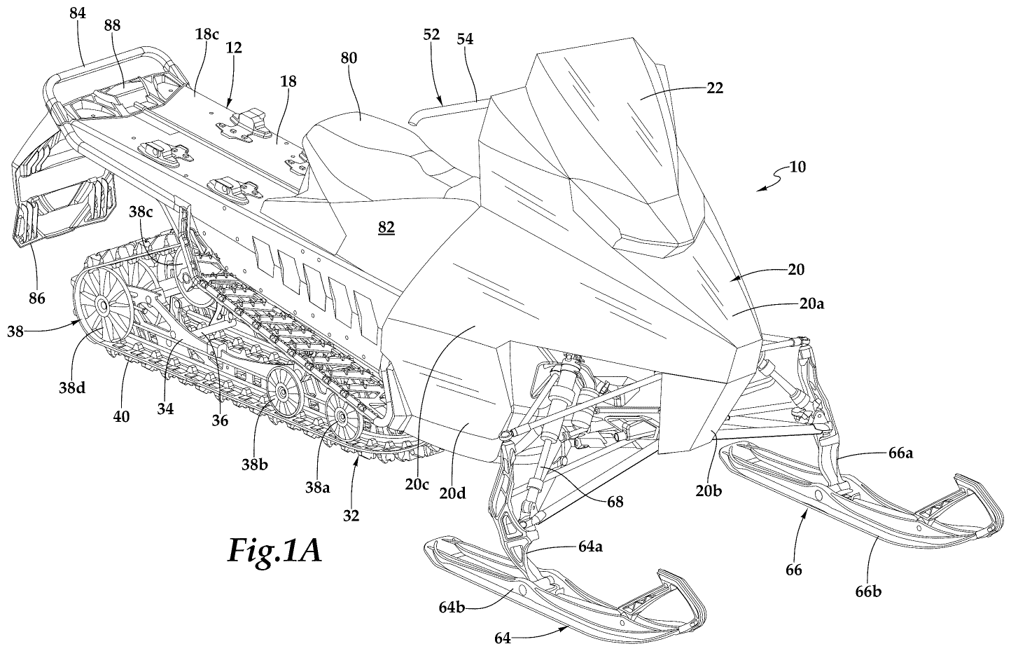

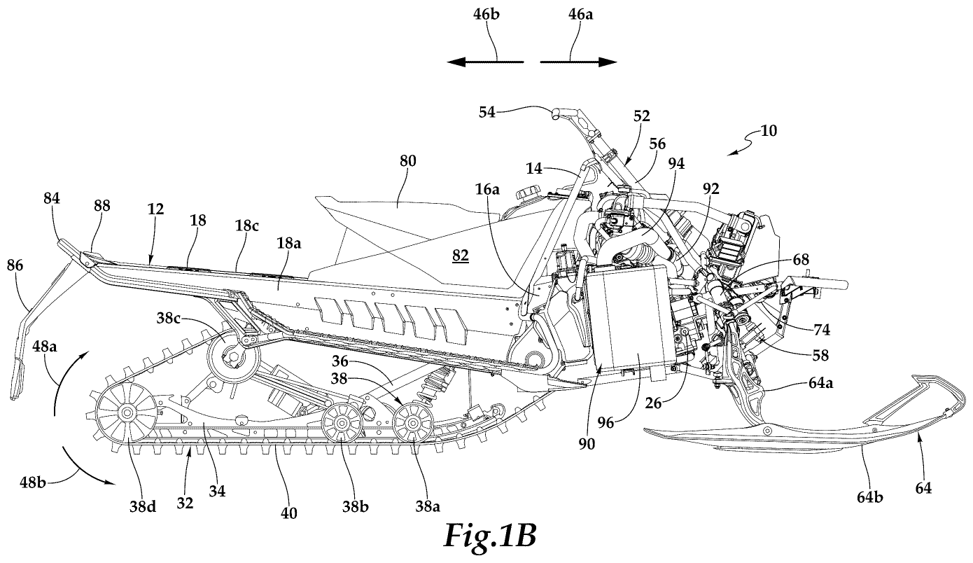

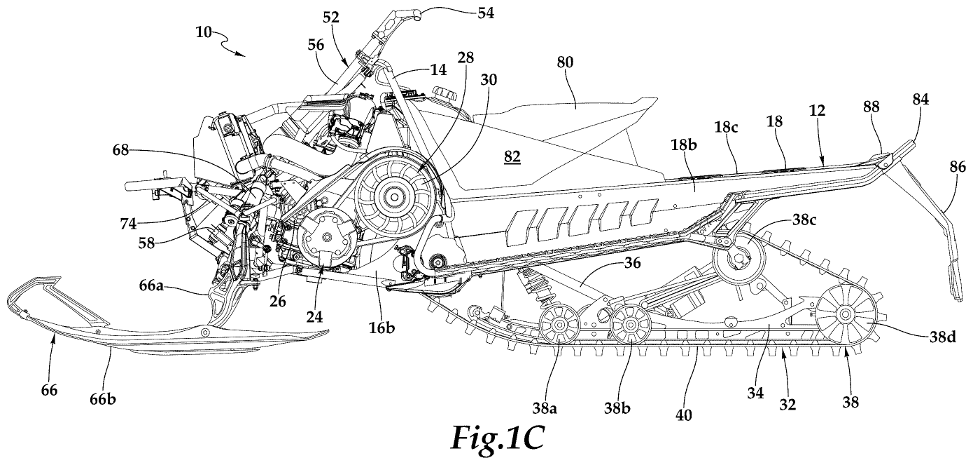

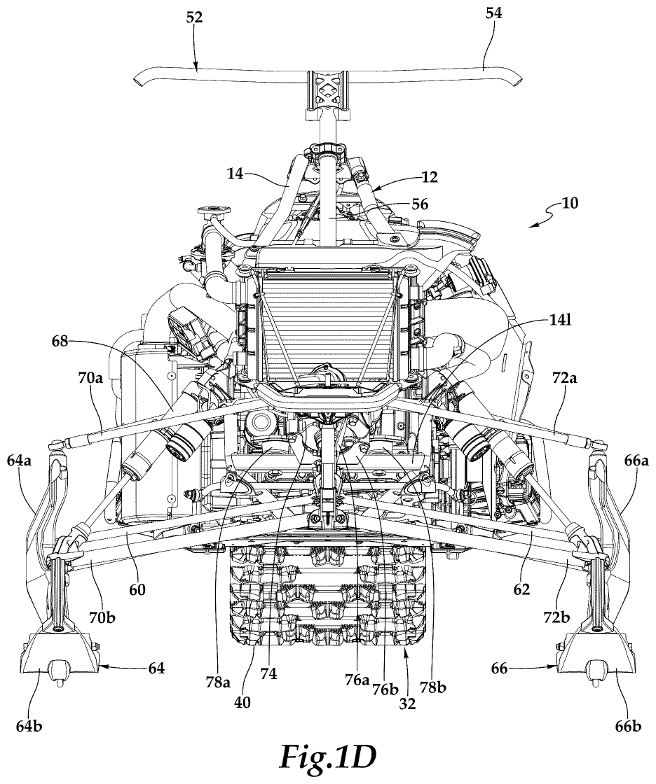

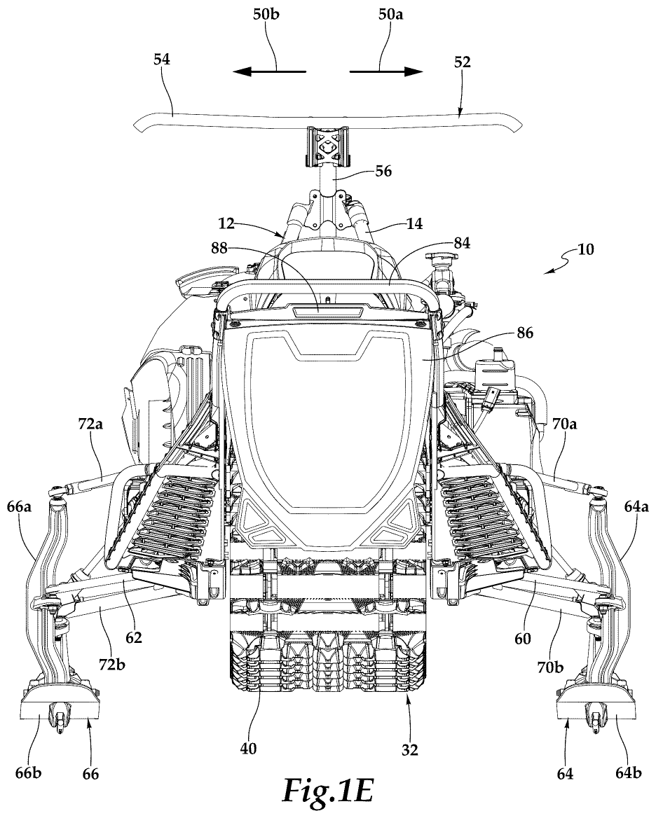

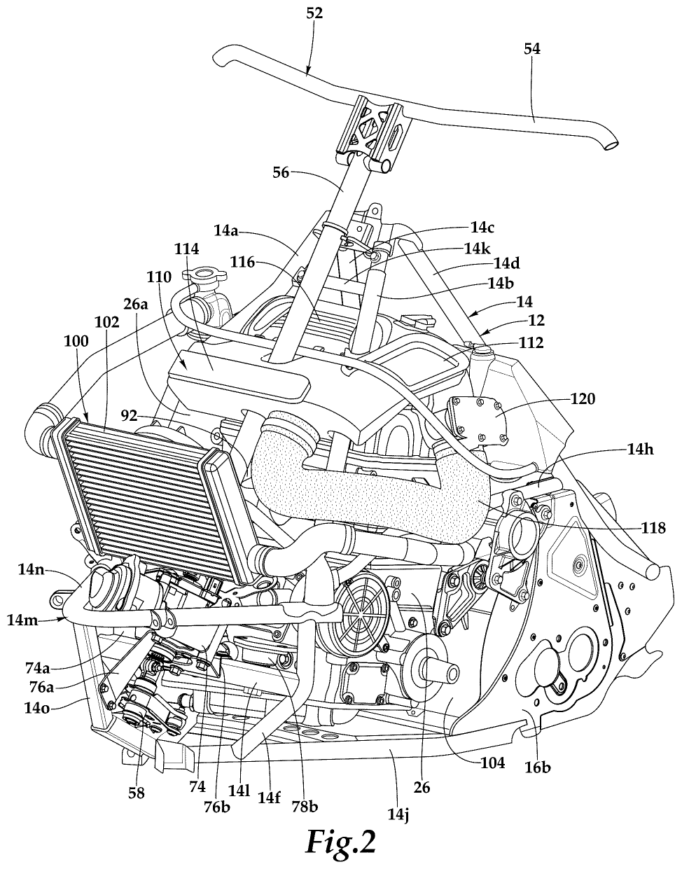

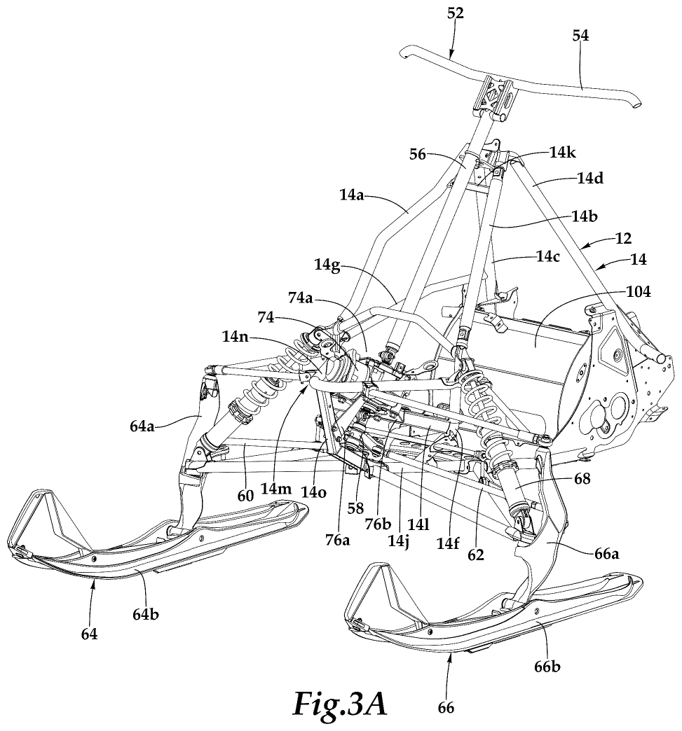

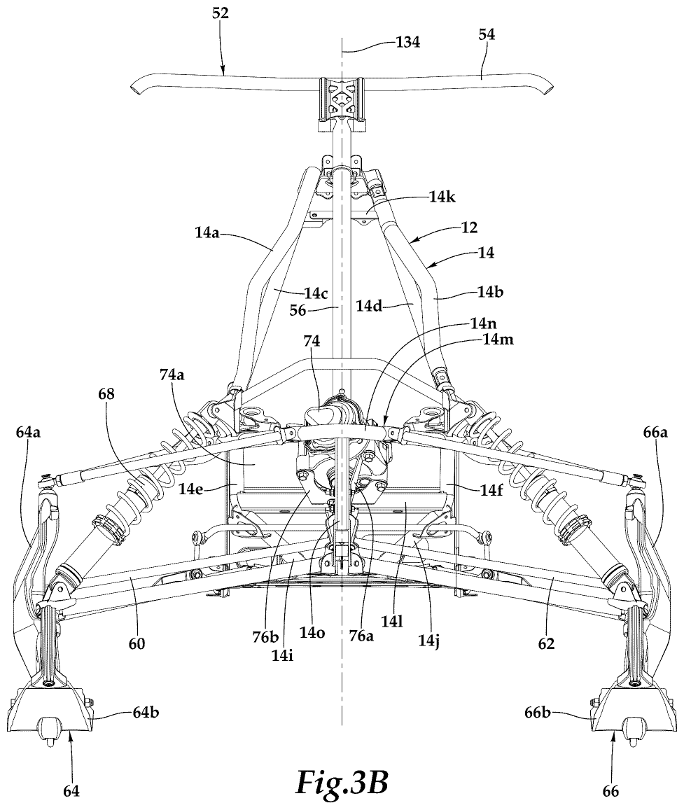

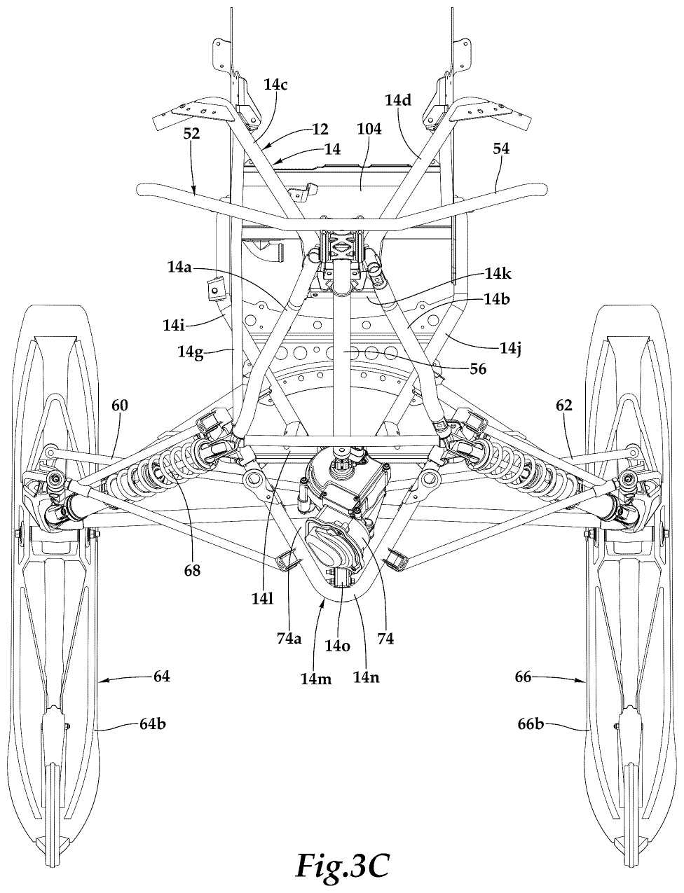

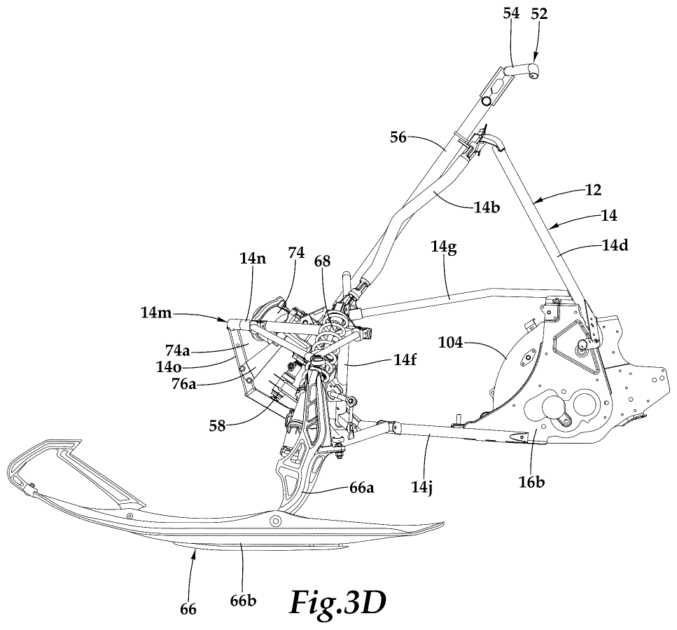

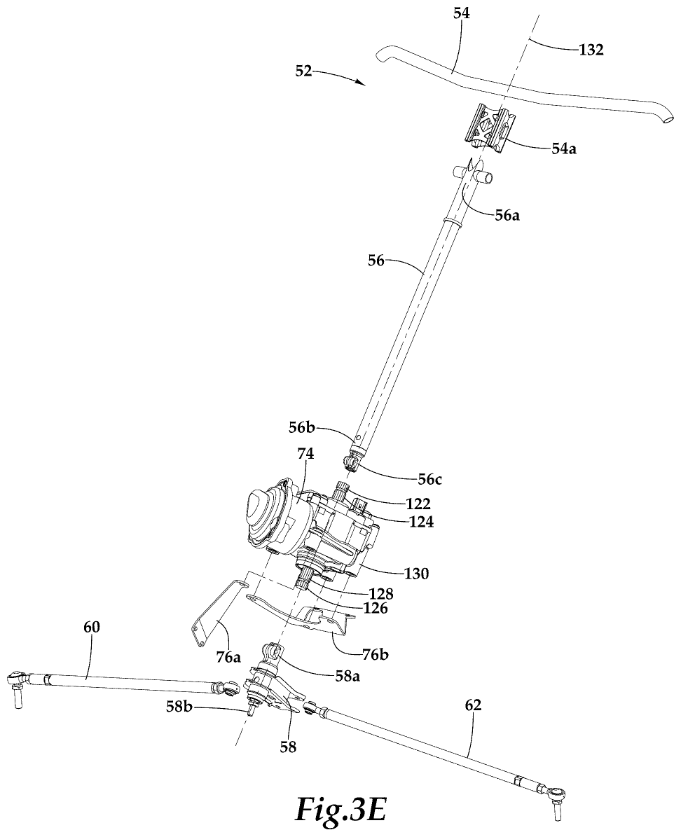

Referring to FIGS. 1A-1E in the drawings, a land vehicle depicted as a snowmobile is schematically illustrated and generally designated 10. Structural support for snowmobile 10 is provided by a chassis 12 that includes a forward frame assembly 14, a right side plate member 16a, a left side plate member 16b and a longitudinally extending tunnel 18. Forward frame assembly 14 (see also FIGS. 2 and 3A-3D) is formed from interconnected tubular members such as round and hollow tubular members comprised of metal, metal alloy, polymeric materials, fiber reinforced polymer composites and/or combinations thereof that are coupled together by welds, bolts, pins or other suitable fastening means. In the illustrated embodiment, forward frame assembly 14 includes a right-forward spar 14a, a left-forward spar 14b, a right-aft spar 14c, a left-aft spar 14d, right truss 14e, a left truss 14f, a right-upper beam 14g, a left-upper beam 14h, a right-lower beam 14i, a left-lower beam 14j, an upper cross member 14k, a lower cross member 14l and a nose frame assembly 14m including a nose rail 14n and a nose truss 14o. Plate members 16a, 16b are coupled to and preferably welded to forward frame assembly 14 such that forward frame assembly 14 and plate members 16a, 16b form a welded frame assembly. Tunnel 18 is coupled to forward frame assembly 14 and/or plate members 16a, 16b with welds, bolts, rivets or other suitable means. In the illustrated embodiment, tunnel 18 includes a right sidewall 18a, a left sidewall 18b and a top panel 18c. Tunnel 18 may be integrally formed or may consist of multiple members that are coupled together with welds, bolts, rivets or other suitable means. Plate members 16a, 16b and tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

Body panels 20 have been removed from snowmobile 10 in FIGS. 1B-1E to reveal the underlying components of snowmobile 10. For example, snowmobile 10 has a powertrain 24 that includes an engine 26 and a drivetrain 28 both of which are coupled to forward frame assembly 14. Engine 26 resides in an engine bay 26a formed within forward frame assembly 14. In the illustrated embodiment, engine 26 is a two-stroke, three cylinder engine that is aftwardly tilted and has air intake inlets on the aftward side of engine 26 and exhaust outlets on the forward side of engine 26. In other embodiments, an engine of the present disclosure may be a four-stroke engine, an electric motor, a hybrid engine or other prime mover. In addition, an engine of the present disclosure may have more than or less than three cylinders, may be vertically mounted or mounted with a forward tilt and/or may have air intake inlets or exhaust outlets in other locations. In the illustrated embodiment, engine 26 is an internal combustion engine such as a naturally aspirated internal combustion engine or a forced induction internal combustion engine that includes, for example, one or more turbochargers and/or superchargers. Engine 26 includes a generator (not visible), such as a three phase permanent magnet generator, which is integrated with engine 26 wherein a flywheel that has permanent magnets attached thereto is rotated by the engine crankshaft about a stator having copper wire coils wrapped around a steel core to generate an alternating current output. This generator will be referred to herein as a stator. The stator may be a multi output stator such as a dual output stator that generates multiple alternating current outputs. The stator is part of a stator system that includes one or more regulator rectifiers that convert the alternating current to direct current. In addition, the regulator rectifiers stabilize the variable voltage produced by the stator and provide a constant voltage output that matches the voltage requirements of the electric load components associated therewith. Drivetrain 28 also includes a transmission 30, such as a continuously variable transmission, an electrically variable transmission or other suitable transmission type for varying the ratio of the engine output speed to the drive track input speed.

A drive track system 32 is at least partially disposed within and/or below tunnel 18 and is in contact with the ground to provide ground propulsion for snowmobile 10. Torque and rotational energy are provided to drive track system 32 from engine 26 via drivetrain 28. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket via a track driveshaft (not visible) that is rotated responsive to torque provided from powertrain 24. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1E. The backward direction may also be referred to herein as the aftward direction.

Snowmobile 10 has a steering system 52 that includes a handlebar assembly 54, a steering column 56, a steering arm assembly 58, a right tie rod 60, a left tie rod 62, a right ski assembly 64 including a right spindle 64a and a right ski 64b, and left ski assembly 66 including a left spindle 66a and a left ski 66b. Right ski assembly 64 and left ski assembly 66 may be referred to collectively as the ski system of snowmobile 10. Snowmobile 10 has a front suspension assembly 68 that is coupled between forward frame assembly 14 and ski assemblies 64, 66 to provide front end support for snowmobile 10. In addition, right ski assembly 64 is coupled to forward frame assembly 14 by upper and lower A-arms 70a, 70b, and left ski assembly 66 is coupled to forward frame assembly 14 by upper and lower A-arms 72a, 72b. Steering system 52 enables the rider to steer snowmobile 10 by rotating handlebar assembly 54 which causes ski assemblies 64, 66 to pivot. In the illustrated embodiment, the pivoting of ski assemblies 64, 66 responsive to rotation of handlebar assembly 54 is assisted by an electric power steering system (EPS) depicted as electronic steering assist unit 74. As best seen in FIG. 2, electronic steering assist unit 74 is positioned within an electronic steering assist unit bay 74a defined by nose assembly 14m. Electronic steering assist unit 74 is coupled to forward frame assembly 14 via a nose bracket 76a that is coupled between electronic steering assist unit 74 and nose truss 14o and an aft bracket 76b that is coupled between electronic steering assist unit 74 and lower cross member 14l. As best seen in FIGS. 1D and 2, lower cross member 14l is positioned between electronic steering assist unit 74 and engine 26. In this position, lower cross member 14l resiliently supports engine 26 via right-front engine mount 78a and left-front engine mount 78b. Aft bracket 76b for electronic steering assist unit 74 is coupled to lower cross member 14l between right-front engine mount 78a and left-front engine mount 78b.

The rider controls snowmobile 10 from a seat 80 that is position atop a fuel tank 82, above tunnel 18, aft of handlebar assembly 54 and aft of forward frame assembly 14. Snowmobile 10 has a lift bumper 84 that is coupled to an aft end of tunnel 18 that enables a person to lift the rear end of snowmobile 10 in the event snowmobile 10 becomes stuck or needs to be repositioned when it is not moving. Snowmobile 10 has a snow flap 86 that deflects snow emitted by endless track 40. In the illustrated embodiment, snow flap 86 is coupled to lift bumper 84. In other embodiments, a snow flap may be coupled directly to tunnel 18. A taillight housing 88 is also coupled to lift bumper 84 and houses a taillight of snowmobile 10. Snowmobile 10 has an exhaust system 90 that includes an exhaust manifold 92 that is coupled to one or more exhaust outlets on the forward side of engine 26, an exhaust duct 94 and a muffler 96. Exhaust system 90 is configured to direct high-temperature exhaust gases away from engine 26 and the rider of snowmobile 10. As exhaust system 90 including exhaust manifold 92 is coupled to the forward side of engine 26, the forward side of engine 26 may be referred to herein as the hot side of engine 26 due to the hot temperatures associated with engine exhaust. The aftward side of engine 26 is concomitantly considered the cool side of engine 26 as hot exhaust system components are located opposite and/or remote therefrom.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

Referring additionally to FIG. 2 of the drawings, further details of snowmobile 10 will now be discussed. In the illustrated embodiments, engine 26 is an aftwardly tilted engine such that an upper portion of engine 26 is aft of a lower portion of engine 26. For example, engine 26 is aftwardly tilted between five degrees and twenty degrees from vertical such as about ten degrees from vertical. It should be understood by those having ordinary skill in the art that engine 26 could have other aftwardly tilted angles both less than five degrees or greater than twenty degrees from vertical. Snowmobile 10 has an engine cooling system 100 that includes a radiator 102 and an arcuate heat exchanger 104. Radiator 102 is coupled to forward frame assembly 14 and more specifically, radiator 102 is coupled to and positioned above nose assembly 14m of forward frame assembly 14. In this location, radiator 102 is positioned forward of engine 26 and is tilted forward such that an upper portion of radiator 102 is forward of a lower portion of radiator 102. Radiator 102 is configured to remove heat from a fluid circulating therethrough responsive to air passing through radiator 102 from the front side of radiator 102 to the rear side of radiator 102. An arcuate heat exchanger 104 is coupled to a forward portion of tunnel 18 and to forward frame assembly 14. In this location, arcuate heat exchanger 104 is positioned aft of engine 26 and below fuel tank 82. Arcuate heat exchanger 104 is configured to remove heat from a fluid circulating therethrough responsive to snow in tunnel 18. For example, during operation of snowmobile 10, endless track 40 kicks snow toward an inner surface of arcuate heat exchanger 104 which is configured to retain at least a portion of this snow. Heat from the fluid circulating through arcuate heat exchanger 104 is transferred to the retained snow causing the retained snow to melt. As discussed herein, electronic steering assist unit 74 is positioned within electronic steering assist unit bay 74a defined by nose assembly 14m with nose bracket 76a coupled between electronic steering assist unit 74 and nose truss 14o and aft bracket 76b coupled between electronic steering assist unit 74 and lower cross member 14l. In this position, electronic steering assist unit 74 is positioned forward of engine 26 and below radiator 102 with at least a portion of electronic steering assist unit 74 forward of radiator 102.

In the illustrated embodiment, engine 26 has an air intake system 110 that receives air from the atmosphere and distributes the air to each of the cylinders of engine 26. More specifically, air intake system 110 includes an air inlet 112 that feeds air into an airbox 114 that is positioned generally forward and generally above engine 26. Air from airbox 114 is routed to an air intake plenum 116 positioned above engine 26 via an air duct 118. The volume of air delivered to air intake plenum 116 from airbox 114 is controlled via a throttle valve assembly 120. Air intake plenum 116 is configured to damp the air flow prior to distribution of the air to the cylinders of engine 26 via air intake runners that extend downwardly and aftwardly from air intake plenum 116 and couple to one or more air inlets positioned on the aftward side of engine 26.

Referring additionally to FIGS. 3A-3E of the drawings, further details relating to steering system 52 of snowmobile 10 will now be disclosed. As discussed herein, steering system 52 includes handlebar assembly 54, steering column 56, steering arm assembly 58, right tie rod 60, left tie rod 62, right ski assembly 64 including right spindle 64a and right ski 64b, and left ski assembly 66 including left spindle 66a and left ski 66b. In addition, steering system 52 includes electronic steering assist unit 74. In the illustrated embodiment, steering column 56 is a straight steering column formed as a non-segmented single post that is positioned forward of upper cross member 14k and along a centerline of snowmobile 10. In other embodiments, the steering column may be a segmented straight steering column that has upper and lower posts, a bent steering column including, for example, a universal joint between upper and lower posts, an articulated steering column that has multiple posts routed around other snowmobile components using multiple joints, a laterally offset steering column that extends downwardly, forwardly and laterally from the handlebar assembly to the lower steering assembly or other suitable connection between the handlebar assembly and the lower steering assembly. As best seen in FIG. 3E, steering column 56 has an upper end 56a and lower end 56b. Upper end 56a of steering column 56 is coupled to handlebar assembly 54 via a handlebar bracket 54a. Lower end 56b of steering column 56 includes a splined coupler 56c that may be integral with or coupled to lower end 56b of steering column 56. Splined coupler 56c receives an input shaft 122 having input splines 124 therein to couple lower end 56b of steering column 56 to electronic steering assist unit 74. Steering arm assembly 58 includes a splined coupler 58a that receives an output shaft 126 having output splines 128 therein such that electronic steering assist unit 74 is coupled directly to steering arm assembly 58 without a steering column post or other extension positioned therebetween. In other embodiments, a steering column post or other extension may be positioned between electronic steering assist unit 74 and steering arm assembly 58. Steering arm assembly 58 is coupled to the proximal ends tie rods 60, 62. The distal ends of tie rods 60, 62 are respectively coupled to ski assemblies 64, 66 such that rotation of handlebar assembly 54 by the rider of snowmobile 10, together with the assist of electronic steering assist unit 74, causes ski assemblies 64, 66 to pivot, thus turning snowmobile 10. A lower end 58b of steering arm assembly 58 is received within a bearing assembly (not visible) of nose truss 14o such that steering arm assembly 58 is operable to rotate relative thereto.

Electronic steering assist unit 74 includes an outer housing 130 that contains the working components thereof including, for example, an electric motor, a torque sensor, a controller and a torsion bar that couples input shaft 122 to output shaft 126. In other embodiments, an electronic steering assist unit may have an alternate shaft configuration including, for example, a single piece shaft design. Outer housing 130 is fixed against rotation relative to forward frame assembly 14 by brackets 76a, 76b. In operation, the input torque applied from handlebar assembly 54 via steering column 56 on input shaft 122 is measured by the torque sensor. Input torque data is then provided to the controller from the torque sensor. Based upon the input torque data and additional factors such as the speed of snowmobile 10, the controller commands the electric motor to provide an output assist torque to output shaft 126 that is additive to the input torque applied to output shaft 126 from input shaft 122 via the torsion bar. The use of electronic steering assist unit 74 improves the handling of snowmobile 10, reduces fatigue associated with driving snowmobile 10 and can allow snowmobile 10 to be driven more aggressively. In addition, coupling electronic steering assist unit 74 directly to steering arm assembly 58 has numerous advantages over prior snowmobile steering systems that have electronic steering assist units including lowering the center of gravity of snowmobile 10 by positioning the electronic steering assist unit at a lowermost location of the steering column. In addition, coupling electronic steering assist unit 74 directly to steering arm assembly 58, together with using a straight steering column 56 and having a common axis of rotation 132 shared by handlebar assembly 54, steering column 56, electronic steering assist unit 74 and steering arm assembly 58 that is positioned along a centerline 134 (see FIG. 3B) of snowmobile 10, reduces the number of parts required in steering system 52 and reduces the complexity of steering system 52, which improves the overall reliability of snowmobile 10.

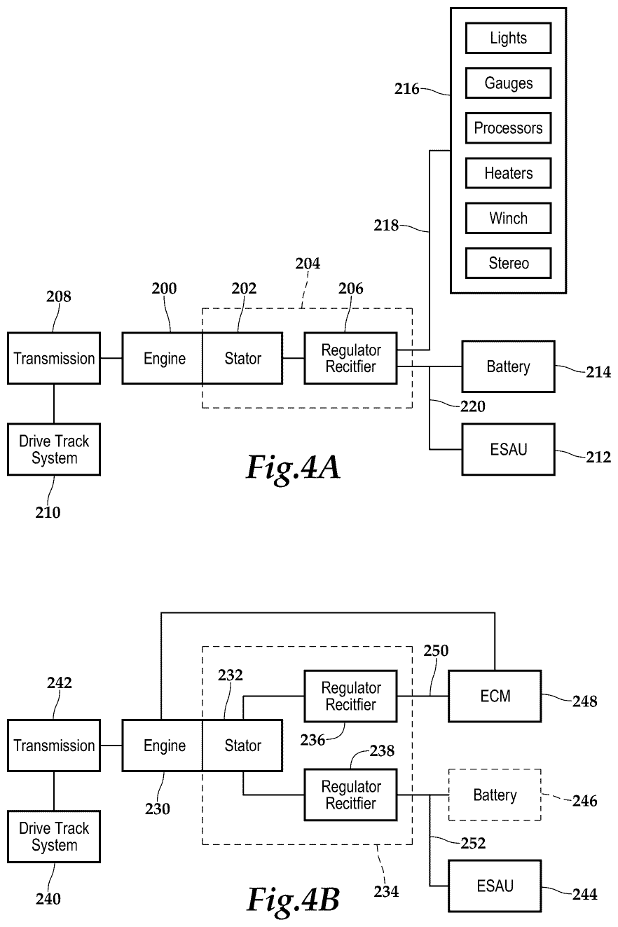

Referring now to FIGS. 4A-4C of the drawings, various electrical system configurations for snowmobiles that are representative of snowmobile 10 and have an electronic steering assist unit, will now be disclosed. In FIG. 4A, a snowmobile includes an engine 200, such as a two-stroke engine, which is operably associated with a stator 202 that is used to generate an alternating current output. In the illustrated embodiment, stator 202 is a component within stator system 204 that also includes a regulator rectifier 206 that is operable to convert the alternating current output generated by stator 202 to multiple isolated direct current outputs that have constant voltages which stabilizes the variable voltage output produced by stator 202. In other stator system embodiments, the regulator functionality and the rectifier functionality could be accomplished in separate components. Likewise, in other stator system embodiments, a regulator rectifier may produce a single direct current output that may be split into multiple isolated direct current outputs by a separate component including, for example, a diode. Engine 200 is operably coupled to a transmission 208, such as a continuously variable transmission or an electrically variable transmission, which is operable to vary the ratio of the engine output speed to the track drive input speed. Transmission 208 is coupled to a drive track system 210 that includes an endless track driven by a track drive sprocket and a track driveshaft such that the endless track provides ground propulsion for the snowmobile. The snowmobile includes a steering system having a steering column that extends between a handlebar assembly and a ski system that provides front end ground support for the snowmobile. The steering system also includes an electronic steering assist unit 212 that is operably coupled to the steering column. The snowmobile also includes a battery 214 and a variety of electrical load components depicted as electrically powered accessories 216 including, for example, lights; gauges; computer processors for controllers, communication systems, GPS systems and the like; heaters such as hand warmers and seat warmers; a winch; a stereo and/or other components that are powered by electricity. Battery 214 may provide power to certain snowmobile components when engine 200 is operating. In addition, battery 214 may provide power to various snowmobile components when engine 200 is not operating such as to memory devices, a clock and snowmobile gauges as well as power to start the snowmobile.

Accessories 216 are designed to operate at a particular voltage, such as 12 VDC, and may be damaged or malfunction if the voltage within the accessory circuit 218 fluctuates significantly above or significantly below the design voltage. An electrical load component such as electronic steering assist unit 212 that has a high power demand as well as an intermittent power demand may tend to cause voltage fluctuations within the circuit in which it resides that can adversely affect other electrical load components within that circuit. The present embodiment avoids such voltage fluctuations in accessory circuit 218 by positioning electronic steering assist unit 212 in a separate circuit, denoted as electronic steering assist unit circuit 220, that is isolated from accessory circuit 218. Specifically, the output current from regulator rectifier 206 that powers accessory circuit 218 is not in communication with the output current that powers electronic steering assist unit circuit 220. Instead, the output current from regulator rectifier 206 that charges battery 214 also powers electronic steering assist unit 212. In the illustrated embodiment, battery 214 and electronic steering assist unit 212 are positioned in parallel within electronic steering assist unit circuit 220 enabling battery 214 to act as a store of energy for electronic steering assist unit 212 such that the intermittent high power demand of electronic steering assist unit 212 may be satisfied by drawing current from battery 214 when such demand exceeds the output from regulator rectifier 206. This unique configuration electrically separates accessory circuit 218 from electronic steering assist unit circuit 220, thereby isolating the intermittent power demand of electronic steering assist unit 212 from accessories 216 and protecting accessories 216 from voltage fluctuations.

In FIG. 4B, a snowmobile includes an engine 230, such as a two-stroke engine, which is operably associated with a stator 232 that is used to generate multiple alternating current outputs. In the illustrated embodiment, stator 232 is a dual output stator and is a component within stator system 234 that also includes a regulator rectifier 236 and a regulator rectifier 238. In other embodiments, the stator could have three, four or more alternating current outputs used to independently power various components or groups of components such as the accessories, an engine control module, the fuel pump, the fuel injectors or other engine or snowmobile systems. Engine 230 is operably coupled to a drive track system 240 via a transmission 242. The snowmobile includes a steering system having a steering column that extends between a handlebar assembly and a ski system. The steering system also includes an electronic steering assist unit 244 that is operably coupled to the steering column. The snowmobile also includes a battery 246 that may optionally be positioned in parallel with electronic steering assist unit 244 such that the output current from regulator rectifier 238 that charges battery 246 also powers electronic steering assist unit 244 with battery 246 acting as a store of energy for electronic steering assist unit 244 such that the intermittent high power demand of electronic steering assist unit 244 may be satisfied by drawing current from battery 246. Alternatively, battery 246 may be on another circuit that does not include electronic steering assist unit 244. The snowmobile includes an electrical load component depicted as engine control module 248 that manages and controls various functions of engine 230 to optimize performance, fuel efficiency and emissions such as regulating fuel injection, ignition timing and the air-fuel mixture as well as monitoring and responding to sensor data.

In the illustrated embodiment, engine control module 248 operates at a first voltage, such as 5 VDC, while electronic steering assist unit 244 operates at a second voltage, such as 12 VDC. To provide the multiple output voltages required by engine control module 248 and electronic steering assist unit 244, stator 232 has two separate coils such that stator 232 is operable to generate two output currents. In the present example, stator 232 has an engine control module coil that outputs an AC voltage to regulator rectifier 236 that in turn supplies 5 VDC to engine control module circuit 250. In addition, stator 232 has an electronic steering assist unit coil that outputs an AC voltage to regulator rectifier 238 that in turn supplies 12 VDC to electronic steering assist unit circuit 252. The present embodiment avoids voltage fluctuations in engine control module 248 by positioning engine module 248 and electronic steering assist unit 244 in separate circuits. This unique configuration not only allows engine control module 248 and electronic steering assist unit 244 to operate at different voltages, but also electrically separates engine control module circuit 250 from electronic steering assist unit circuit 252, thereby isolating the intermittent power demand of electronic steering assist unit 244 from engine control module 248. It should be noted that the engine control module may send trigger signals to power on and off the electronic steering assist units of the present disclosure. In addition, the engine control module may provide controller functionality for the electronic steering assist units of the present disclosure. In some embodiments, the electronic steering assist units of the present disclosure may be powered on and off manually enabling both a power steering mode and a manual steering mode for the snowmobile.

In FIG. 4C, a snowmobile includes an engine 260, such as a two-stroke engine, which is operably associated with a stator 262 that is used to generate two alternating current outputs. In the illustrated embodiment, stator 262 is a dual output stator and is a component within stator system 264 that also includes a regulator rectifier 266 and a regulator rectifier 268. Engine 260 is operably coupled to a drive track system 270 via a transmission 272. The snowmobile includes a steering system having a steering column that extends between a handlebar assembly and a ski system. The steering system also includes an electronic steering assist unit 274 that is operably coupled to the steering column. The snowmobile also includes a battery 276 that may optionally be positioned in parallel with electronic steering assist unit 274 such that the output current from regulator rectifier 268 that charges battery 276 also powers electronic steering assist unit 274 with battery 276 acting as a store of energy for electronic steering assist unit 274 such that the intermittent high power demand of electronic steering assist unit 274 may be satisfied by drawing current from battery 276. Alternatively, battery 276 may be on another circuit that does not include electronic steering assist unit 274. The snowmobile includes a variety of electrical load components depicted as accessories 278 including, for example, lights; gauges; computer processors for controllers, communication systems, GPS systems and the like; heaters such as hand warmers and seat warmers; a winch; a stereo and/or other components that are powered by electricity.

In the illustrated embodiment, accessories 278 and electronic steering assist unit 274 may operates at the same or different voltages. In either case, stator 262 has an accessories coil that outputs an AC voltage to regulator rectifier 266 that in turns supplies the desired voltage, such as 12 VDC, to accessories circuit 280. In addition, stator 262 has an electronic steering assist unit coil that outputs an AC voltage to regulator rectifier 268 that in turn supplies the desired voltage, such as 12 VDC, to electronic steering assist unit circuit 282. As such, the present embodiment avoids voltage fluctuations in accessories 278 by positioning accessories 278 and electronic steering assist unit 274 in separate circuits. This unique configuration not only allows accessories 278 and electronic steering assist unit 244 to operate at different voltages (if desired), but also electrically separates accessories circuit 280 from electronic steering assist unit circuit 282, thereby isolating the intermittent power demand of electronic steering assist unit 274 from accessories 278.

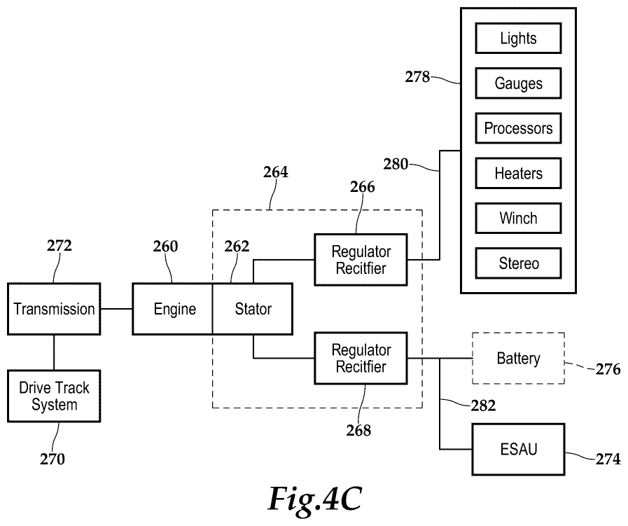

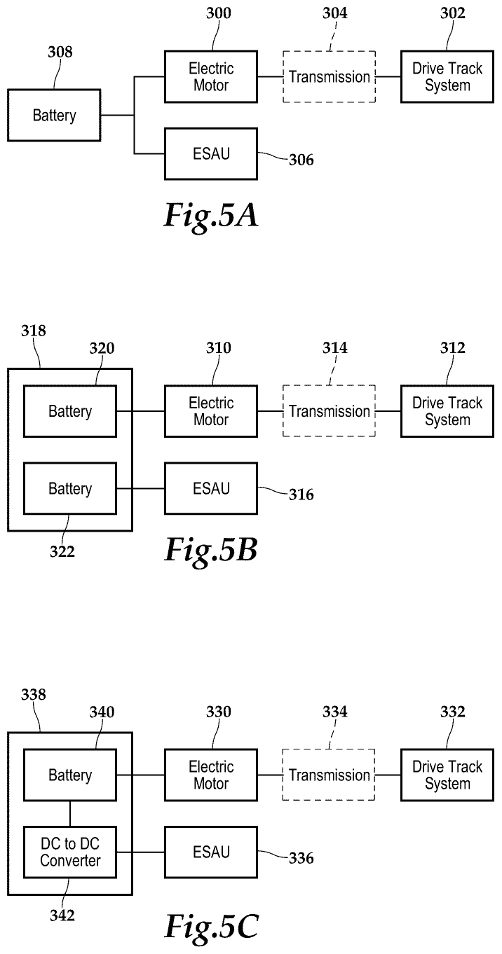

Referring now to FIGS. 5A-5C of the drawings, various electrical system configurations for snowmobiles that are representative of snowmobile 10 and has an electronic steering assist unit, will now be disclosed. In FIG. 5A, a snowmobile includes an electric motor 300 that operates at a design voltage of, for example, at least 48 VDC such as between 48 VDC and 300 VDC. Electric motor 300 is operably coupled to a drive track system 302 that includes an endless track driven by a track drive sprocket and a track driveshaft such that the endless track provides ground propulsion for the snowmobile. An optional transmission 304 may be positioned between electric motor 300 and drive track system 302. The snowmobile includes a steering system having a steering column that extends between a handlebar assembly and a ski system that provides front end ground support for the snowmobile. The steering system also includes an electronic steering assist unit 306 that is operably coupled to the steering column. The snowmobile has a power supply that includes, for example, a plurality of battery cells and a battery management system, depicted as battery 308 that has a suitable capacity and voltage for operating electric motor 300 for a desired period of time. In the illustrated embodiment, electronic steering assist unit 306 operates at the same voltage as electric motor 300, such as 48 VDC, enabling electronic steering assist unit 306 and electric motor 300 to reside in the same circuit. Battery 308 is configured to maintain a substantially constant output voltage with variations in load current such that the intermittent power demands of electronic steering assist unit 306 and electric motor 300 tend not to cause voltage fluctuations within the circuit and thus, electronic steering assist unit 306 and electric motor 300 need not be isolated from one another on separate circuits.

In FIG. 5B, a snowmobile includes an electric motor 310 that operates at a design voltage of, for example, at least 48 VDC such as between 48 VDC and 300 VDC. Electric motor 310 is operably coupled to a drive track system 312 via an optional transmission 314. The snowmobile includes a steering system having a steering column that extends between a handlebar assembly and a ski system that provides front end ground support for the snowmobile. The steering system also includes an electronic steering assist unit 316 that is operably coupled to the steering column. Electronic steering assist unit 316 operates at a design voltage of, for example, 12 VDC. The snowmobile has a power supply 318 that includes, for example, a high voltage battery 320 and a low voltage battery 322. In the illustrated embodiment, battery 320 supplies electric power to electric motor 310 while battery 322 supplies electric power to electronic steering assist unit 316. In this manner, each of electric motor 310 and electronic steering assist unit 316 may operate at a desired voltage.

In FIG. 5C, a snowmobile includes an electric motor 330 that operates at a design voltage of, for example, at least 48 VDC such as between 48 VDC and 300 VDC. Electric motor 330 is operably coupled to a drive track system 332 via an optional transmission 334. The snowmobile includes a steering system having a steering column that extends between a handlebar assembly and a ski system that provides front end ground support for the snowmobile. The steering system also includes an electronic steering assist unit 336 that is operably coupled to the steering column. Electronic steering assist unit 336 operates at a design voltage of, for example, 12 VDC. The snowmobile has a power supply 338 that includes, for example, a high voltage battery 340 and a voltage converter depicted as DC to DC converter 342. In the illustrated embodiment, battery 340 supplies electric power to electric motor 330 at the high voltage level and supplies electric power to electronic steering assist unit 336 at the lower voltage level via DC to DC converter 342. In this manner, each of electric motor 330 and electronic steering assist unit 336 may operate at a desired voltage.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A snowmobile having a ski system, the snowmobile comprising:
a drive track system including an endless track configured to provide ground propulsion for the snowmobile;
an internal combustion engine configured to provide torque and rotational energy to the drive track system;
a stator system operably associated with the engine, the stator system configured to output first and second direct currents;
at least one electrical load component positioned in a first circuit associated with the first direct current; and
a steering system operatively coupled to the ski system, the steering system including an electronic steering assist unit;
wherein, the electronic steering assist unit is positioned in a second circuit associated with the second direct current.

2. The snowmobile as recited in claim 1 wherein, the engine is a two-stroke engine.

3. The snowmobile as recited in claim 1 wherein, the at least one electrical load component is an engine control module.

4. The snowmobile as recited in claim 1 wherein, the at least one electrical load component includes one or more of lights, gauges, computer processors, heaters, a winch and a stereo.

5. The snowmobile as recited in claim 1 wherein, the stator system further comprises a stator and a regulator rectifier;
wherein, the stator outputs an alternating current to the regulator rectifier; and
wherein, the regulator rectifier outputs the first direct current to the first circuit and the second direct current to the second circuit.

6. The snowmobile as recited in claim 5 further comprising a battery positioned in parallel with the electronic steering assist unit in the second circuit;
wherein, the battery is configured to be charged by the second direct current; and
wherein, the battery is configured as a store of energy for the electronic steering assist unit such that an intermittent high power demand of the electronic steering assist unit is satisfied by drawing current from the battery.

7. The snowmobile as recited in claim 1 wherein, the stator system further comprises a stator, a first regulator rectifier and a second regulator rectifier;
wherein, the stator outputs a first alternating current to the first regulator rectifier and a second alternating current to the second regulator rectifier; and
wherein, the first regulator rectifier outputs the first direct current to the first circuit and the second regulator rectifier outputs the second direct current to the second circuit.

8. The snowmobile as recited in claim 7 further comprising a battery positioned in parallel with the electronic steering assist unit in the second circuit;
wherein, the battery is configured to be charged by the second direct current; and
wherein, the battery is configured as a store of energy for the electronic steering assist unit such that an intermittent high power demand of the electronic steering assist unit is satisfied by drawing current from the battery.

9. The snowmobile as recited in claim 1 wherein, the first and second direct currents are at the same voltage.

10. The snowmobile as recited in claim 1 wherein, the first and second direct currents are at different voltages.

11. The snowmobile as recited in claim 1 further comprising a battery that is configured to be charged by the second direct current.

12. The snowmobile as recited in claim 11 wherein, the battery is positioned in parallel with the electronic steering assist unit in the second circuit; and
wherein, the battery is configured as a store of energy for the electronic steering assist unit such that an intermittent high power demand of the electronic steering assist unit is satisfied by drawing current from the battery.

13. A snowmobile having a ski system, the snowmobile comprising:
a drive track system including an endless track configured to provide ground propulsion for the snowmobile;
an electric motor configured to provide torque and rotational energy to the drive track system;
a steering system operatively coupled to the ski system, the steering system including an electronic steering assist unit; and
a power supply configured to supply electric power to the electric motor and the electronic steering assist unit.

14. The snowmobile as recited in claim 13 wherein, the power supply further comprises a battery having an output voltage; and
wherein, both the electric motor and the electronic steering assist unit operate at the output voltage.

15. The snowmobile as recited in claim 14 wherein, the output voltage of the battery is between 48 volts and 300 volts.

16. The snowmobile as recited in claim 13 wherein, the electric motor operates at a first voltage and the electronic steering assist unit operates at a second voltage that is less than the first voltage; and
wherein, the power supply further comprises a first battery having an output voltage of the first voltage and a second battery having an output voltage of the second voltage.

17. The snowmobile as recited in claim 16 wherein, the first voltage is between 48 volts and 300 volts; and
wherein, the second voltage is about 12 volts.

18. The snowmobile as recited in claim 13 wherein, the electric motor operates at a first voltage and the electronic steering assist unit operates at a second voltage that is less than the first voltage; and
wherein, the power supply further comprises a battery having an output voltage of the first voltage and a DC to DC converter electrically coupled between the battery and the electronic steering assist unit, the DC to DC converter configured to convert the first voltage to the second voltage.

19. The snowmobile as recited in claim 18 wherein, the first voltage is between 48 volts and 300 volts; and
wherein, the second voltage is about 12 volts.

20. A method of electrically isolating an electronic steering assist unit from at least one electrical load component of a snowmobile, the method comprising:
outputting first and second direct currents from a stator system operably associated with an internal combustion engine;
positioning the at least one electrical load component in a first circuit associated with the first direct current; and
positioning the electronic steering assist unit in a second circuit associated with the second direct current.
